(19) United States
(12) Patent Application Publication
(10) Pub. No.: US 2025/0085736 A1
(43) Pub. Date: Mar. 13, 2025

(54) AUTOMOBILE PEDAL PROTECTIVE SLEEVE

(71) Applicant: Shenzhen Jiadun Supply Chain Management Co., Ltd., Shenzhen (CN)

(72) Inventor: Feng XIAO, Yingcheng (CN)

(73) Assignee: Shenzhen Jiadun Supply Chain Management Co., Ltd., Shenzhen (CN)

(21) Appl. No.: 18/479,554

(22) Filed: Oct. 2, 2023

(30) Foreign Application Priority Data
Sep. 12, 2023 (CN) 2023224817235

(51) Int. Cl. G05G 25/04; G05G 1/483

(52) U.S. Cl. CPC G05G 25/04; G05G 1/483

(57) ABSTRACT

An automotive pedal protective sleeve is disclosed according to the present application, comprising a protective cover and gasket, the protective cover is buckled and wrapped on the pedal, and the gasket is arranged at one side of the protective cover. A pedal accommodating groove for accommodating a pedal is defined on one side of the protective cover facing the gasket, a positioning groove is defined on one side of the protective cover facing the gasket for accommodating the gasket, the protective cover is connected to the main body of the pedal under the limiting effect of the gasket. The present application solve the problems of poor wear resistance, poor anti slip effect of rubber pedal protective sleeve, and complex matching of metal protective sleeves in conventional technologies.

### CROSS-REFERENCE TO RELATED APPLICATIONS

The application claims priority to Chinese patent application No. 2023224817235, filed on Sep. 12, 2023, the entire contents of which are incorporated herein by reference.

### TECHNICAL FIELD

The present application relates to the field of pedal sleeves, and in particular to an automobile pedal protective sleeve.

### BACKGROUND

With the rapid development of the automotive industry, people have increasingly high requirements for automotive components not only in terms of functionality but also in terms of appearance, beautiful and practical products always attract customers' attention. As the market competition becomes more and more fierce, the automobile industry pays more and more attention to the improvement of automobile appearance and practicality. A pedal sleeve is mounted on a brake pedal, a clutch pedal, or an accelerator pedal of an automobile, and is a component that a driver may directly step on with his feet. It is also an accessory that the driver may intuitively feel. The existing pedal sleeves on the market generally use directly integrated black rubber pedal sleeves with various patterns for anti slip, not only is it unattractive, but after a period of use, a tread pattern of the pedal sleeve may wear out, and the anti slip effect may be weakened. On the market, some pedal sleeves with metal sheaths are generally fixed with screws, which are used to secure the metal sheath to the pedal sleeve, its cost is high, and the assembly is complex, and there is a risk of metal sheath detachment.

### SUMMARY

An object of the present application is to: an automotive pedal protective sleeve is proposed, so as to solve the problems of poor wear resistance, poor anti slip effect of rubber pedal protective sleeve, and complex matching of metal protective sleeves in conventional technologies.

In order to achieve the above object, the application adopts the following technical solution: an automobile pedal protective sleeve, including a protective cover and gasket, the protective cover is buckled and wrapped on the pedal, and the gasket is arranged at one side of the protective cover. A pedal accommodating groove for accommodating a pedal is defined on one side of the protective cover facing the gasket, a positioning groove is defined on one side of the protective cover facing the gasket for accommodating the gasket, the protective cover is connected to the main body of the pedal under the limiting effect of the gasket.

As a further description of the above technical solution: the protective cover consists of a protective sleeve and a metal sleeve. The protective sleeve is positioned between the gasket and the metal sleeve, the metal sleeve is coated on an outer side of the protective sleeve, the protective sleeve is buckled and wrapped on the automobile pedal body, the pedal accommodating groove is defined on the protective sleeve and faces one side of the gasket, the positioning groove is defined on the protective sleeve and faces one side of the gasket, the positioning groove is located at an outer side of the pedal accommodating groove.

As a further description of the above technical solution: the protective sleeve is made of soft material, and the gasket is made of metal material.

As a further description of the above technical solution: the protective sleeve is made of rubber or silica gel, and the gasket is made of stainless steel or aluminum alloy.

As a further description of the above technical solution: a connecting hole is defined on the protective sleeve and the metal sleeve, a threaded hole is defined on the gasket. The connecting hole corresponds to the threaded hole, the metal sleeve, the protective sleeve and the gasket are connected by bolts or screws.

As a further description of the above technical solution: connecting holes are defined at corresponding positions of the protective sleeve and the metal sleeve, a clamping hole is defined on the gasket, the connecting hole corresponds to the clamping hole, and the metal sleeve, the protective sleeve and the gasket are connected by buckles.

As a further description of the above technical solution: a clamping rod is fixedly arranged on an inner top surface of the metal sleeve, a barbed head is arranged at one end of the clamping rod far from a lower side of the metal sleeve, a connecting hole is defined on the protective sleeve, a limiting hole is defined on the gasket, the connecting hole corresponds to the clamping rod, and the limiting hole corresponds to the barbed head.

As a further description of the above technical solution: there are four connecting holes and are connected in a rectangular shape, and the four connecting holes are distributed in the four corners of the rectangle, an upper side surface of the protective sleeve is provided with a limiting counterbore, which is located at a peripheral side of the connecting hole, a countersunk tube is provided at an outer side surface of the metal sleeve, and the countersunk tube is located above the connecting hole, the countersunk tube is coaxial with the connecting hole, and a positioning tube is arranged inside the metal sleeve, the positioning tube corresponds to the connecting hole, and the positioning tube corresponds to the limiting counterbore.

As a further description of the above technical solution: there are four connecting holes and are connected in a rectangular shape, and the four connecting holes are distributed in the four corners of the rectangle, the upper side of the protective sleeve is provided with a limiting counterbore, which is located at the peripheral side of the connecting hole, a positioning head is arranged on an inner top surface of the metal sleeve, and the clamping rod is arranged on the positioning head. The positioning head corresponds to the limiting counterbore.

As a further description of the above technical solution: the protective sleeve and the metal sleeve are integrally formed or detachably connected.

As a further description of the above technical solution: a limiting flange is arranged at one end of the protective sleeve facing a connecting rod of the pedal, which is used to buckle the main part of the pedal to prevent the pedal from shifting, a pedal limiting groove is formed between the limiting flange and the protective sleeve, the limiting flange and the protective sleeve are integrally formed.

As a further description of the above technical solution: a limiting flange is arranged at one end of the protective sleeve facing a connecting rod of the pedal, which is used to buckle the main part of the pedal to prevent the pedal from shifting, a pedal limiting groove is formed between the limiting flange and the protective sleeve, the limiting flange is rotatably connected with the protective sleeve.

As a further description of the above technical solution: the gasket is U-shaped, and a U-shaped opening of the gasket corresponds to the limiting flange.

As a further description of the above technical solution: a side limiting strip is arranged on the gasket.

As a further description of the above technical solution: an end limiting strip is arranged on the gasket.

As a further description of the above technical solution: a side of the gasket far away from the U-shaped opening is rotatably connected with the metal sleeve.

As a further description of the above technical solution: the metal sleeve is a metal housing with an opening on one side, and circular and square holes are defined on the metal sleeve.

As a further description of the above technical solution: an anti-skid protrusion and an anti-skid bump are arranged on an upper side surface of the protective sleeve, the anti-skid protrusion corresponds to the circular hole, and the anti-skid bump corresponds to the square hole.

To sum up, due to the adoption of the technical solution, the application has the following beneficial effects:

(1) The protective sleeve is simple in structure, convenient and quick to mount, by providing a protective sleeve, the area of the pedal body is further increased, giving the driver a clearer foot feel. Through the protection of the metal sleeve, the protective sleeve has better wear resistance, under the action of the gasket, the pedal accommodating groove and the positioning groove of the protective sleeve, the main part of the pedal is more firmly and stably connected with the protective sleeve.

(2) The protective sleeve, metal sleeve, and gasket are connected together through bolts or buckles, making the connection more secure and components not easy to fall off, the overall assembly is simple. In addition, the limiting flange rotatably connected with the protective sleeve may well limit the pedal body, and it is convenient to insert the pedal body into the pedal accommodating groove of the protective sleeve.

(3) The anti-skid protrusions and bumps on the protective sleeve, as well as the anti-skid patterns on the bumps, further enhance the friction between the driver's foot and the protective sleeve, the reduction of the contact area between the sole and the protective sleeve may further reduce the wear of the protective sleeve, and when the anti-skid protrusion and the anti-skid bump are fixed between the protective sleeve and the metal sleeve in a detachable way, they can be more conveniently replaced in case of wear.

### BRIEF DESCRIPTION OF DRAWINGS

FIG. 1 is a schematic view of a three-dimensional structure of a first embodiment of the present application;

FIG. 2 is an exploded view of the first embodiment of the present application:

FIG. 3 is another exploded view of the first embodiment of the present application:

FIG. 4 is an exploded view of a second embodiment of the present application:

FIG. 5 is a schematic structural view of a connection relationship between a metal sleeve and a gasket in the second embodiment of the present application:

FIG. 6 is a side view of a protective sleeve in a third embodiment of the present application:

FIG. 7 is a schematic view of a buckle structure in the third embodiment of the present application:

FIG. 8 is a three-dimensional structural view of the protective sleeve in the third embodiment of the present application, wherein a limiting flange rotates to a position far from a pedal accommodating groove:

FIG. 9 is a three-dimensional structural view of another angle of the protective sleeve in the third embodiment of the present application, wherein the limiting flange rotates to a position far from the pedal accommodating groove:

FIG. 10 is a schematic structural view of a fourth embodiment of the present application:

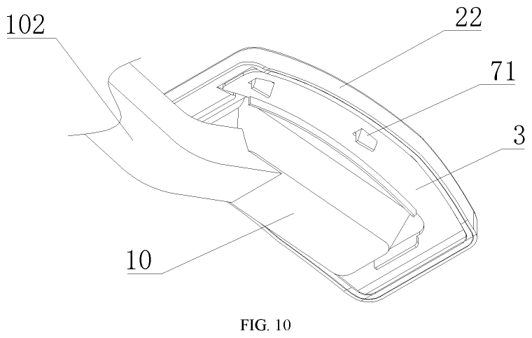

FIG. 11 is an exploded view of the fourth embodiment of the present application:

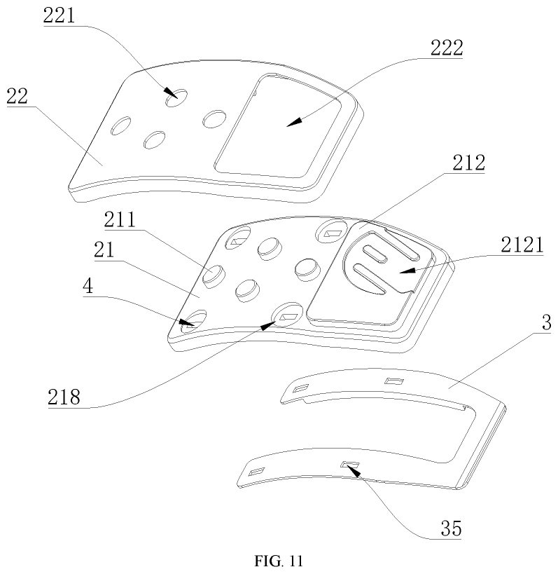

FIG. 12 is an exploded view from another perspective of the fourth embodiment of the present application:

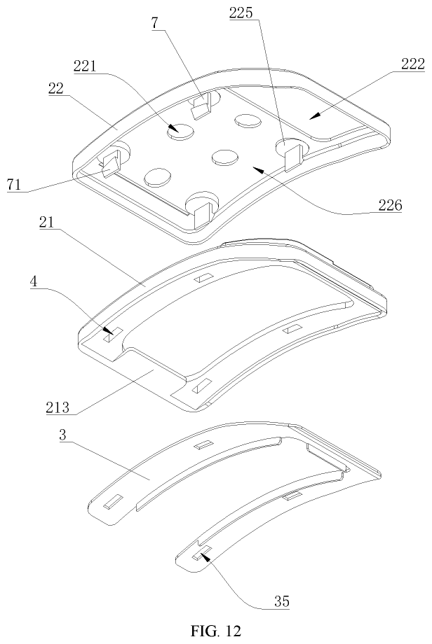

FIG. 13 is a schematic view of a pedal protective sleeve structure used for a brake pedal or clutch pedal in the present application.

Reference numerals in the drawings: 10, pedal; 101, main body; 102, connecting rod; 2, protective cover; 21, protective sleeve; 211, anti-skid protrusion; 212, anti-skid bump; 2121, anti-skid pattern; 213, limiting flange; 214, pedal accommodating groove; 215, positioning groove; 216, upper side surface; 217, lower side surface; 218, limiting counterbore; 219, pedal limiting groove; 22, metal sleeve; 220, outer side surface; 221, circular hole; 222, square hole; 223, countersunk tube; 224, positioning tube; 225, positioning head; 226, inner top surface; 3, gasket; 30, inner side surface; 31, side limiting strip; 32, end limiting strip; 33, threaded hole; 34, clamping hole; 35, limiting hole; 4, connecting hole; 5, buckle; 51, umbrella dome; 6, screw; 7, clamping rod; 71, barbed head.

### DETAILED DESCRIPTION OF THE EMBODIMENTS

In the following, the technical solution in the embodiment of the application is clearly and completely described with reference to the drawings in the embodiment of the application. Apparently, the described embodiment is only a part of the embodiment of the application, but not the whole embodiment. Based on the embodiments in this application, all other embodiments obtained by ordinary technicians in this field without creative work belong to the protection scope of this application.

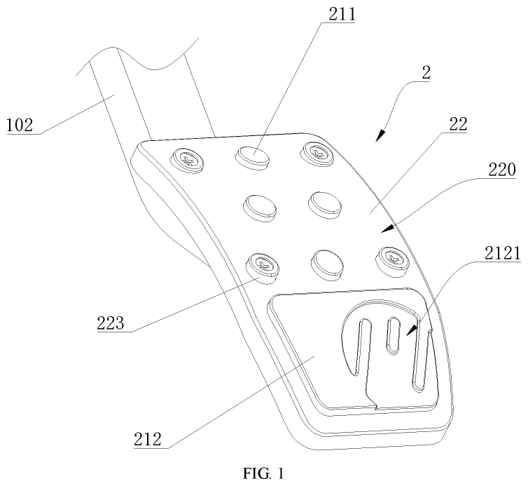

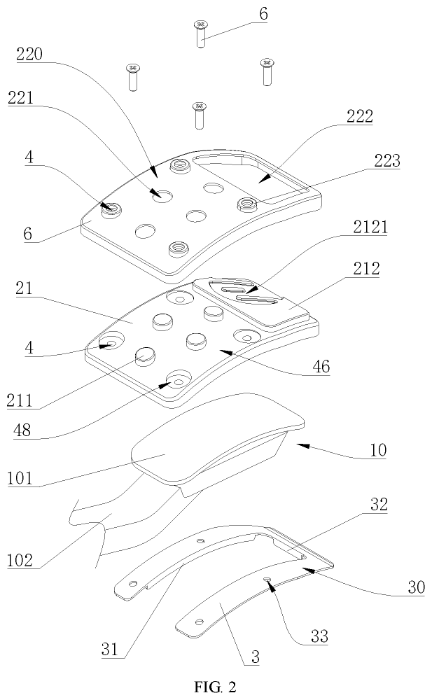

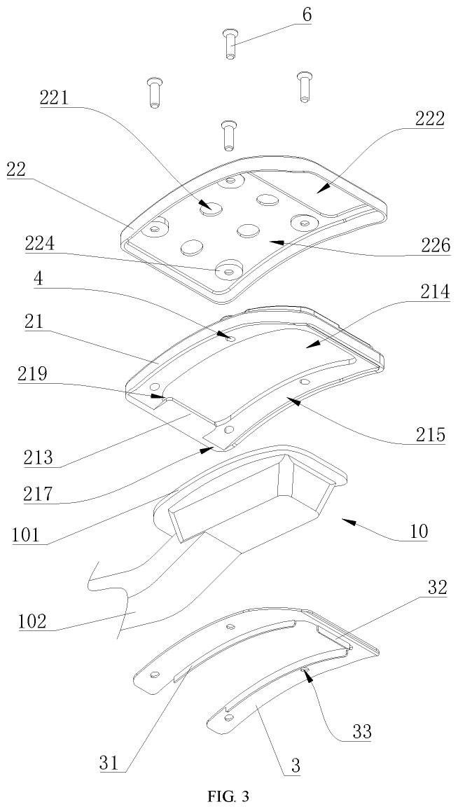

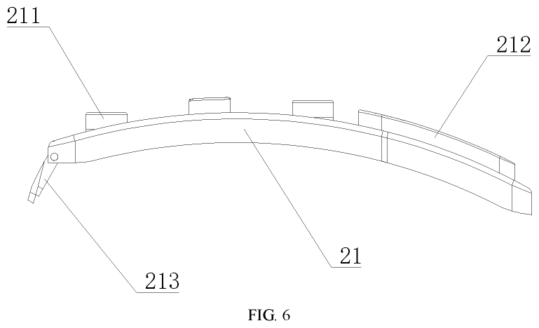

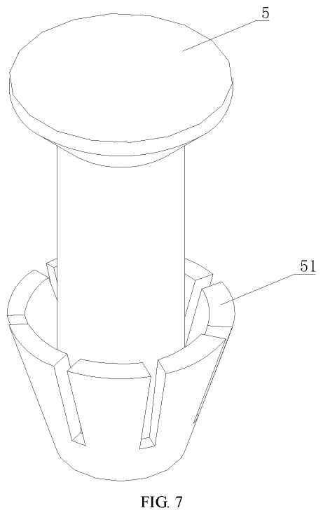

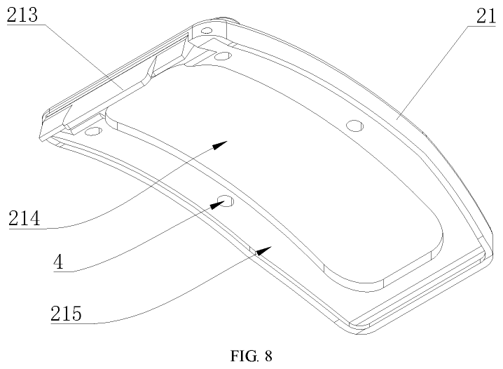

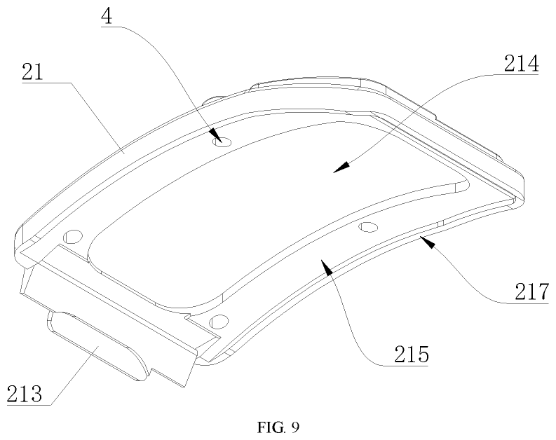

Referring to FIG. 1 to FIG. 9, a technical scheme of an automobile pedal protective sleeve is provided according to the present application:

### First Embodiment

Referring to FIG. 1 to FIG. 3, an automobile pedal protective sleeve, including a protective cover 2 and a gasket 3, the protective cover 2 consists of a protective sleeve 21 and a metal sleeve 22, the protective sleeve 21 is made of soft material, in this embodiment, the protective sleeve 21 is made of rubber material. In other embodiments, the protective sleeve 21 may be made of silicone, the protective sleeve 21 is arc-shaped as a whole, and is buckled and wrapped on the pedal. An anti-skid protrusion 211 and an anti-skid bump 212 are arranged on an upper side surface 216 of the protective sleeve 21. In this embodiment, the anti-skid projection 211 and the anti-skid bump 212 are integrally formed with the protective sleeve 21. In other embodiments, the anti-skid projection 211 and the anti-skid bump 212 may be detachably fixed between the protective sleeve 21 and the metal sleeve 22, the number of anti-skid protrusions 211 is set according to an area of the upper side surface 216 of the protective sleeve 21, the anti-skid protrusions 211 are spaced apart evenly, and one anti-skid bump 212 is provided, the anti-skid bump 212 is provided with anti-skid patterns 2121. The anti-skid protrusion 211 and the anti-skid bump 212 may increase friction.

The gasket 3 is made of U-shaped metal, specifically, stainless steel. The metal sleeve 22 is a metal housing with one side open, and is made of stainless steel or aluminum alloy. The metal sleeve 22 is defined with circular holes 61 corresponding to the anti-skid protrusion 211 and square holes 222 corresponding to the anti-skid bump 212. In case that the metal sleeve 22 is covered on the protective sleeve 21, the anti-skid protrusion 211 protrudes from the inside of the metal sleeve 22 through the circular hole 61, and the anti-skid bump 212 protrudes from the inside of the metal sleeve 22 through the square hole 222.

Connecting holes 4 are formed at corresponding positions on the protective sleeve 21 and the metal sleeve 22, there are four connecting holes 4 and are connected in a rectangular shape, and the four connecting holes 4 are distributed in the four corners of the rectangle, an upper side surface 216 of the protective sleeve 21 is provided with a limiting counterbore 218, which is located at a peripheral side of the connecting hole 4, a countersunk tube 223 is provided at an outer side surface 60 of the metal sleeve 22, and the countersunk tube 223 is located above the connecting hole 4, the countersunk tube 223 is coaxial with the connecting hole 4, and a positioning tube 224 is arranged inside the metal sleeve 22, the positioning tube 224 corresponds to the connecting hole 4, and the positioning tube 224 corresponds to the limiting counterbore 218. A threaded hole 33 is formed in the gasket 3, and the connecting hole 4 corresponds to the threaded hole 33 one by one. The metal sleeve 22, the protective sleeve 21 and the gasket 3 are connected by screws 6 or bolts, in this embodiment, the protective sleeve 21 is detachably connected with the metal sleeve 22, the protective sleeve 21 and the connecting sleeve are separately arranged. In other embodiments, the protective sleeve 21 is integrally formed with the metal sleeve 22.

The protective sleeve 21 is sandwiched between the gasket 3 and the metal sleeve 22, a side of the protective sleeve 21 facing the gasket 3, that is, a lower side surface 217 of the protective sleeve 21 is defined with a pedal accommodating groove 214 for accommodating the pedal 10. The pedal accommodating groove 214 is curved and has a rectangular shape overall, and the main body 101 of the pedal 10 is adapted to the pedal accommodating groove 214. A side of the protective sleeve 21 facing the gasket 3, that is, the lower side surface 217 of the protective sleeve 21 is defined with a positioning groove 215 for accommodating the gasket 3. The positioning groove 215 is arranged around the pedal accommodating groove 214, and the positioning groove 215 is U-shaped, a groove depth of the pedal accommodating groove 214 is greater than a groove depth of the positioning groove 215, the gasket 3 is fitted in the positioning groove 215, and a width of the gasket 3 is greater than a width of the positioning groove 215. A limiting flange 213 is defined on one end of the protective sleeve 21 facing the connecting rod 102 of the pedal 10, which is used for locking the main body 101 of the pedal 10 to prevent the pedal 10 from shifting. A pedal limiting groove 219 is formed between the limiting flange 213 and the protective sleeve 21, the limiting flange 213 is integrally formed with the protective sleeve 21, a U-shaped opening of the gasket 3 corresponds to the limiting flange 213. A side limiting strip 31 is arranged on the gasket 3. An end limiting strip 32 is provided on the gasket 3, which is opposite to the limiting flange 213. By arranging the side limiting strips 31 and the end limiting strips 32, the protective sleeve 21 may be further limited to avoid displacement during installation, and the strength of the gasket 3 is enhanced. In case that the main body 101 of the pedal 10 is partially fitted in the pedal accommodating groove 214, in case of mounting gasket 3, under the action of the limiting flange 213, the protective sleeve 21 is pre-fixed with the main body 101 of pedal 10, after the gasket 3 is mounted in the positioning groove 215, the inner side surface 30 of the gasket 3 partially compresses and limits the main body 101 of the pedal 10 in the pedal accommodating groove 214.

The working principle: in the pedal protective sleeve of the first embodiment of the application, in case of mounting, firstly, the protective sleeve 21 is buckled and sleeved on the main body 101 of the pedal 10, so that the pedal accommodating groove 214 of the protective sleeve 21 is covered on the main body 101 of the pedal 10. The limiting flange 213 limits the main body 101 of the pedal 10, and then places the gasket 3 in the positioning groove 215, the metal sleeve 22 is covered on the protective sleeve 21, so that the positioning tubes 224 are in one-to-one correspondence with the limiting counterbores 218. Finally, the metal sleeve 22, the protective sleeve 21 and the gasket 3 are connected together by screws 6, the screw 6 is completely located in the countersunk tube 223, so that the main body 101 of the pedal 10 is fixed together with the protective sleeve 21 under the action of the gasket 3 and the limiting flange 213.

### Second Embodiment

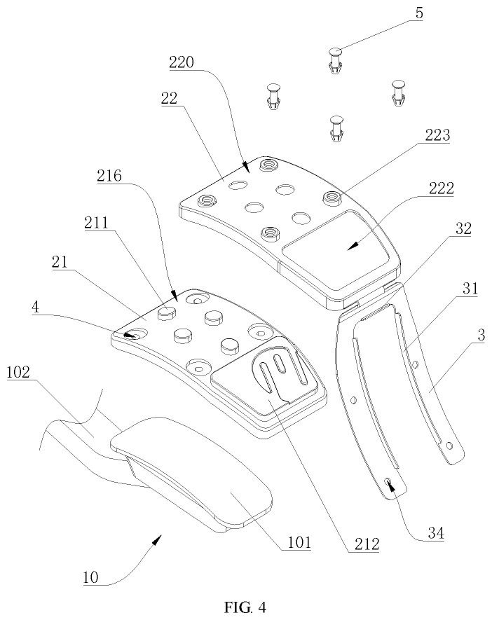

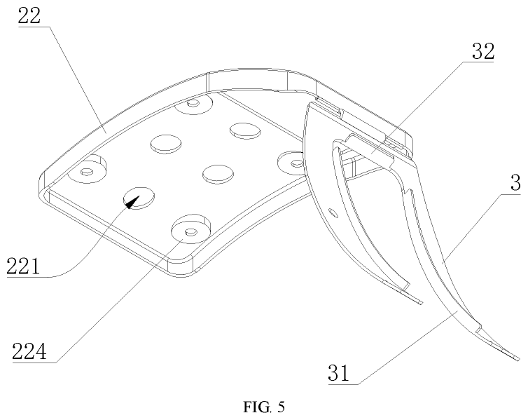

In order to make the overall installation of the automobile pedal protection sleeve more convenient and efficient, referring to FIG. 4 to FIG. 5.

An automobile pedal protective sleeve, including a protective sleeve 21, a gasket 3, a metal sleeve 22, the protective sleeve 21 is made of soft material, in this embodiment, the protective sleeve 21 is made of rubber material, the protective sleeve 21 is arc-shaped as a whole, and is buckled and wrapped on the pedal 10. An anti-skid protrusion 211 and an anti-skid bump 212 are arranged on an upper side surface 216 of the protective sleeve 21. The anti-skid protrusion 211 and the anti-skid bump 212 are integrally formed with the protective sleeve 21, the number of anti-skid protrusions 211 is set according to the area of the upper side surface 216 of the protective sleeve 21, the anti-skid protrusions are spaced at equal distances, and one anti-skid bump 212 is set. The anti-skid bump 212 is provided with anti-skid patterns 2121. The anti-skid protrusion 211 and the anti-skid bump 212 may increase friction.

The gasket 3 is made of metal material, specifically, stainless steel or aluminum alloy material, the gasket 3 is U-shaped, and the metal sleeve 22 is a metal housing with an opening on one side, the metal sleeve 22 is made of aluminum alloy, and is defined with circular holes 61 corresponding to the anti-skid protrusion 211 and square holes 222 corresponding to the anti-skid bump 212. In case that the metal sleeve 22 is covered on the protective sleeve 21, the anti-skid protrusion 211 protrudes from the inside of the metal sleeve 22 through the circular hole 61, and the anti-skid bump 212 protrudes from the inside of the metal sleeve 22 through the square hole 222.

Connecting holes 4 are formed at corresponding positions on the protective sleeve 21 and the metal sleeve 22, there are four connecting holes 4 and are connected in a rectangular shape, and the four connecting holes 4 are distributed in the four corners of the rectangle, an upper side surface 216 of the protective sleeve 21 is provided with a limiting counterbore 218, which is located at a peripheral side of the connecting hole 4, a countersunk tube 223 is provided at an outer side surface 60 of the metal sleeve 22, and the countersunk tube 223 is located above the connecting hole 4, the countersunk tube 223 is coaxial with the connecting hole 4, and a positioning tube 224 is arranged inside the metal sleeve 22, the positioning tube 224 corresponds to the connecting hole 4, and the positioning tube 224 corresponds to the limiting counterbore 218. The side of the gasket 3 far away from its U-shaped opening is rotatably connected with the metal sleeve 22, a rotating shaft and a connecting plate are arranged on the metal sleeve 22, the connecting plate is rotatably connected to the metal sleeve 22, and is fixedly connected with the gasket 3. A clamping hole 34 is defined on the gasket 3, which corresponds to the connecting hole 4 of the metal sleeve 22, the metal sleeve 22, the protective sleeve 21 and the gasket 3 are connected through the buckle 5, an umbrella dome 51 is arranged at one end of the buckle 5, during installation, the gasket is inserted by the counterbore tube of the metal sleeve 22, so that the umbrella dome 51 of the buckle 5 passes through the clamping hole 34 to achieve positioning, and the connection through the buckle 5 is more firm and the installation is quick.

The protective sleeve 21 is sandwiched between the gasket 3 and the metal sleeve 22, a side of the protective sleeve 21 facing the gasket 3, that is, a lower side surface 217 of the protective sleeve 21 is defined with a pedal accommodating groove 214 for accommodating the pedal 10. The pedal accommodating groove 214 is curved and has a rectangular shape overall, and the main body 101 of the pedal 10 is adapted to the pedal accommodating groove 214. A side of the protective sleeve 21 facing the gasket 3, that is, the lower side surface 217 of the protective sleeve 21 is defined with a positioning groove 215 for accommodating the gasket 3. The positioning groove 215 is arranged around the pedal accommodating groove 214, and the positioning groove 215 is U-shaped, a groove depth of the pedal accommodating groove 214 is greater than a groove depth of the positioning groove 215, the gasket 3 is fitted in the positioning groove 215, and a width of the gasket 3 is greater than a width of the positioning groove 215. A limiting flange 213 is defined on one end of the protective sleeve 21 facing the connecting rod 102 of the pedal 10, which is used for locking the main body 101 of the pedal 10 to prevent the pedal 10 from shifting. A pedal limiting groove 219 is formed between the limiting flange 213 and the protective sleeve 21, the limiting flange 213 is integrally formed with the protective sleeve 21, a U-shaped opening of the gasket 3 corresponds to the limiting flange 213. A side limiting strip 31 is arranged on the gasket 3. An end limiting strip 32 is provided on the gasket 3, which is opposite to the limiting flange 213. By arranging the side limiting strips 31 and the end limiting strips 32, the protective sleeve 21 may be further limited to avoid displacement during installation. In case that the main body 101 of the pedal 10 is partially fitted in the pedal accommodating groove 214, in case of mounting gasket 3, under the action of the limiting flange 213, the protective sleeve 21 is pre-fixed with the main body 101 of pedal 10, after the gasket 3 is mounted in the positioning groove 215, the inner side surface 30 of the gasket 3 partially compresses and limits the main body 101 of the pedal 10 in the pedal accommodating groove 214.

The working principle: in case of mounting the automobile pedal protective sleeve, firstly, the protective sleeve 21 is buckled and covered on the main body 101 of the pedal 10, so that the pedal accommodating groove 214 of the protective sleeve 21 is covered on the main body 101 of the pedal 10, and the limiting flange 213 limits the main body 101 of the pedal 10, then the metal sleeve 22 is buckled on the protective sleeve 21, so that the positioning tubes 224 are in one-to-one correspondence with the limiting counterbores 218. The gasket 3 rotates around the metal sleeve 22, so that the gasket 3 is located in the positioning groove 215, and the inner side surface 30 of the gasket 3 presses the main body 101 of the pedal 10. Finally, the metal sleeve 22, the protective sleeve 21 and the gasket 3 are connected together by the buckle 5, the buckle 5 passes through the countersunk tube 223, the connecting hole 4 and the positioning tube 224 of the metal sleeve 22, then passes through the connecting hole 4 of the protective sleeve 21, and finally passes through the clamping hole 34 to clamp the countersunk tube 223, the connecting hole 4 and the positioning tube 224 together. Meanwhile, the pedal 10 is stably located in the pedal accommodating groove 214 of the protective sleeve 21, and one end of the buckle 5 is completely located in the countersunk tube 223.

### Third Embodiment

In case of placing the protective sleeve 21 on the main body 101 of the pedal 10, due to the function of the integrally arranged limiting flange 213, the main body 101 of the pedal 10 may be stably limited in the pedal accommodating groove 214 and is not easy to fall off. However, it also makes it difficult for the main body 101 of pedal 10 to be mounted in the pedal accommodation groove 214, in this embodiment, in order to conveniently and quickly mount the main body 101 of the pedal 10 into the pedal accommodating groove 214, this embodiment is different from the first embodiment or the second embodiment in that, one end of the protective sleeve 21 facing the connecting post of the pedal 10 is provided with a limiting flange 213, which is used to buckle the main body 101 of the pedal 10 to prevent the pedal 10 from shifting. The limiting flange 213 is rotatably connected with the protective sleeve 21, and a torsion spring (not shown in the attached figure) is arranged at the rotating shaft thereof. In case that the main body 101 of the pedal 10 is located in the pedal accommodating groove 214, the limiting flange 213 is pressed against one side of the main body 101 of the pedal 10 under the action of the torsion spring, in case that the gasket 3 is mounted in the positioning groove 215, both ends of the U-shaped opening of the gasket 3 are pressed against both ends of the limiting flange 213.

The working principle: the difference from the first embodiment or the second embodiment is that, in case that the main body 101 of the pedal 10 is mounted in the pedal accommodating groove 214, first, it is necessary to rotate the limiting flange 213 away from the pedal accommodating groove 214, so that the main body 101 of the pedal 10 may be directly put into the pedal accommodating groove 214, and then loosen the limiting flange 213, under the action of the torsion spring, the limiting flange 213 presses the main body 101 of the pedal 10 into the pedal accommodating groove 214, so that the subsequent installation of the gasket 3 and the metal sleeve 22 is more convenient.

### Fourth Embodiment

In order to further facilitate the installation and disassembly of the protective sleeve 21, the metal sleeve 22 and the gasket 3, the difference between this embodiment and other embodiments is that, there are four connecting holes 4 and are connected in a rectangular shape, and the four connecting holes 4 are distributed in the four corners of the rectangle, an upper side surface 216 of the protective sleeve 21 is provided with a limiting counterbore 218, which is located at a peripheral side of the connecting hole 4, An inner top surface 226 of the metal sleeve 22 is provided with a positioning head 225, and the clamping rod 7 is arranged on the positioning head 225, and the positioning head 225 corresponds to and adapts to the limiting counterbore 218. A barbed head 71 is arranged at one end of the clamping rod 7 far from the lower side surface 217 of the metal sleeve 22, a connecting hole 4 is defined in the protective sleeve 21, and a clamping hole 35 is defined in the gasket 3. The connecting hole 4 corresponds to the clamping rod 7, and the clamping hole 35 corresponds to the barbed head 71.

The working principle: in case that the protective sleeve 21, the metal sleeve 22 and the gasket 3 are mounted together with the pedal 10, first, the main body 101 of the pedal 10 is mounted in the pedal accommodating groove 214 of the protective sleeve 21, then the gasket 3 is put into the positioning groove 215, finally, the metal sleeve 22 is mounted, firstly, the positioning head 225 of the metal sleeve 22 is made to correspond to the limiting counterbore 218, and the clamping rod 7 passes through the connecting hole 4, when the barbed head 71 passes through the limiting hole 35, the protective sleeve 21, the metal sleeve 22 and the gasket 3 are connected together and the main body 101 of the pedal 10 is stably and firmly connected together.

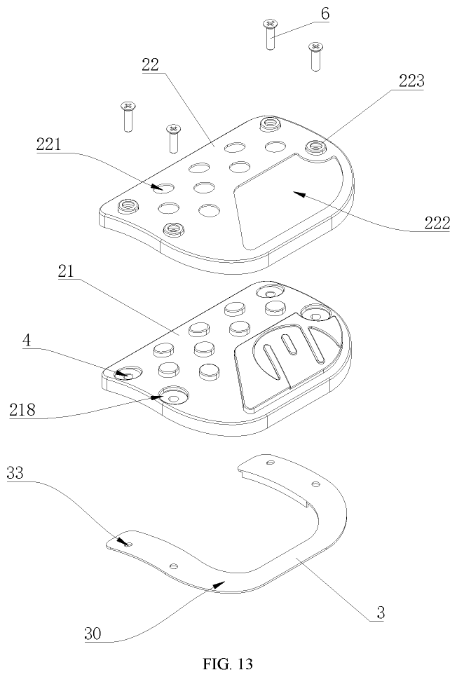

The automobile pedal accommodating groove 214 of the present application may be used for the automobile accelerator pedal 10, as shown in FIG. 1, the automobile pedal accommodating groove 214 of the present application may also be used for the automobile brake pedal 10 or the clutch pedal 10, as shown in FIG. 13. The difference between the pedal protective sleeve used for the automobile accelerator pedal 10 and the automobile brake pedal or clutch pedal is that the size of the protective sleeve is different.

The above is only the preferred embodiment of this application, but the protection scope of this application is not limited to this. Those familiar with the technical field should be included in the protection scope of this application if they are replaced or changed equally according to the technical scheme and inventive concept of this application within the technical scope disclosed in this application.

What is claimed is:

1. An automotive pedal protective sleeve, comprising a protective cover (2) and gasket (3), wherein the protective cover (2) is buckled and wrapped on the pedal (10), and the gasket (3) is arranged at one side of the protective cover (2), a pedal accommodating groove (214) for accommodating a pedal (10) is defined on one side of the protective cover (2) facing the gasket (3), a positioning groove (215) is defined on one side of the protective cover (2) facing the gasket (3) for accommodating the gasket (3), the protective cover (2) is connected to the main body (101) of the pedal (10) under the limiting effect of the gasket (3).

2. The automotive pedal protective sleeve according to claim 1, wherein the protective cover (2) comprises of a protective sleeve (21) and a metal sleeve (22), the protective sleeve (21) is positioned between the gasket (3) and the metal sleeve (22), the metal sleeve (22) is coated on an outer side of the protective sleeve (21), the protective sleeve (21) is buckled and wrapped on the main body (101) of the pedal (10), the pedal accommodating groove (214) is defined on the protective sleeve (21) and faces one side of the gasket (3), the positioning groove (215) is defined on the protective sleeve (21) and faces one side of the gasket (3), the positioning groove (215) is located at an outer side of the pedal accommodating groove (214).

3. The automotive pedal protective sleeve according to claim 2, wherein the protective sleeve (21) is made of soft material, and the gasket (3) is made of metal material.

4. The automotive pedal protective sleeve according to claim 2, wherein the protective sleeve (21) is made of rubber or silica gel, and the gasket (3) is made of stainless steel or aluminum alloy.

5. The automotive pedal protective sleeve according to claim 2, wherein a connecting hole (4) is defined on the protective sleeve (21) and the metal sleeve (22), a threaded hole (33) is defined on the gasket (3), the connecting hole (4) corresponds to the threaded hole (33), the metal sleeve (22), the protective sleeve (21) and the gasket (3) are connected by bolts (6) or screws.

6. The automotive pedal protective sleeve according to claim 2, wherein connecting holes (4) are defined at corresponding positions of the protective sleeve (21) and the metal sleeve (22), a clamping hole (34) is defined on the gasket (3), the connecting hole (4) corresponds to the clamping hole (34), and the metal sleeve (22), the protective sleeve (21) and the gasket (3) are connected by buckles (5).

7. The automotive pedal protective sleeve according to claim 2, wherein a clamping rod (7) is fixedly arranged on an inner top surface (226) of the metal sleeve (22), a barbed head (71) is arranged at one end of the clamping rod (7) far from a lower side of the metal sleeve (22), a connecting hole (4) for connecting the clamping rod (7) is defined on the protective sleeve (21), a limiting hole (35) for connecting the barbed head (71) is defined on the gasket (3), the connecting hole (4) corresponds to the clamping rod (7), and the limiting hole (35) corresponds to the barbed head (71).

8. The automotive pedal protective sleeve according to claim 5, wherein there are four connecting holes (4) and are connected in a rectangular shape, and the four connecting holes (4) are distributed in the four corners of the rectangle, an upper side surface (216) of the protective sleeve (21) is provided with a limiting counterbore (218), which is located at a peripheral side of the connecting hole (4), a countersunk tube (223) is provided at an outer side surface (220) of the metal sleeve (22), and the countersunk tube (223) is located above the connecting hole (4), the countersunk tube (223) is coaxial with the connecting hole (4), and a positioning tube (224) is arranged at an inner top surface (226) of the metal sleeve (22), the positioning tube (224) corresponds to the connecting hole (4), and the positioning tube (224) corresponds to the limiting counterbore (218).

9. The automotive pedal protective sleeve according to claim 7, wherein there are four connecting holes (4) and are connected in a rectangular shape, and the four connecting holes (4) are distributed in the four corners of the rectangle, the upper side surface (216) of the protective sleeve (21) is provided with a limiting counterbore (218), which is located at the peripheral side of the connecting hole (4), a positioning head (225) is arranged on an inner top surface (226) of the metal sleeve (22), and the clamping rod (7) is arranged on the positioning head (225), the positioning head (225) corresponds to the limiting counterbore (218).

10. The automotive pedal protective sleeve according to claim 2, wherein the protective sleeve (21) and the metal sleeve (22) are integrally formed or detachably connected.

11. The automotive pedal protective sleeve according to claim 2, wherein the protective sleeve (21) is provided with a limiting flange (213) for buckling the main body (101) of the pedal (10), and the limiting flange (213) is located at one end of the protective sleeve (21) facing the connecting rod (102) of the pedal (10) to prevent the pedal (10) from shifting:
wherein a pedal limiting groove (219) is formed between the limiting flange (213) and the protective sleeve (21), and the limiting flange (213) and the protective sleeve (21) are integrally formed.

12. The automotive pedal protective sleeve according to claim 2, wherein a limiting flange (213) is provided at one end of the protective sleeve (21) facing the connecting column of the pedal (10), which is used for buckling the main body (101) of the pedal (10) to prevent the pedal (10) from shifting:
wherein a pedal limiting groove (219) is formed between the limiting flange (213) and the protective sleeve (21), the limiting flange (213) is rotatably connected with the protective sleeve (21).

13. The automotive pedal protective sleeve according to claim 11, wherein the gasket (3) is U-shaped, and a U-shaped opening of the gasket (3) corresponds to the limiting flange (213).

14. The automotive pedal protective sleeve according to claim 13, wherein a side limiting strip (31) is arranged on the gasket (3).

15. The automotive pedal protective sleeve according to claim 14, wherein an end limiting strip (32) is arranged on the gasket (3).

16. The automotive pedal protective sleeve according to claim 13, wherein a side of the gasket far away from the U-shaped opening is rotatably connected with the metal sleeve.

17. The automotive pedal protective sleeve according to claim 2, wherein the metal sleeve (22) is a metal housing with an opening on one side, and circular holes (221) and square holes (222) are defined on the metal sleeve (22).

18. The automotive pedal protective sleeve according to claim 17, wherein an anti-skid protrusion (211) and an anti-skid bump (212) are arranged on an upper side surface (216) of the protective sleeve (21), the anti-skid protrusion (211) corresponds to the circular hole (221), and the anti-skid bump (212) corresponds to the square hole (222).
